(19) United States
(12) Patent Application Publication
(10) Pub. No.: US 2010/0224652 A1
(43) Pub. Date: Sep. 9, 2010

(54) DEVICE FOR OPENING AND SHUTTING NOZZLE OF COSMETIC CASE

(75) Inventor: Jun-Kuk Lim, Gyeonggi-do (KR)

Correspondence Address: LEVINE & MANDELBAUM, 222 Bloomingdale Road, Suite 203, WHITE PLAINS, NY, 10605, US

(73) Assignee: TOLY KOREA, INC., Gyeonggi-do (KR)

(21) Appl. No.: 12/726,987

(22) Filed: Mar. 18, 2010

(30) Foreign Application Priority Data
Mar. 3, 2009 (KR) 2009-0017850

(51) Int. Cl. B65D 47/34; G01F 11/00

(52) U.S. Cl. 222/256; 222/559

(57) ABSTRACT

A device for opening a nozzle during use of a cosmetics case and closing the nozzle during non-use has an operation button and a guide pipe with a rod-shaped pin for opening and closing the nozzle and a push pin with a ring-shaped engagement recess parallel to the rod-shaped pin. A rear side of the push pin is engaged with a spring enabling the pin for opening and shutting the nozzle and the push pin to move forward. The support axis of the operation button is provided with an operation lever that is pivoted about a hinge hole which is a support point and is in engagement with the push pin for opening and closing the nozzle when the button is pressed. The nozzle is opened before a pumping operation for smoothly discharging the cosmetics. Thereafter and until the next use of the case, the nozzle is closed by the elastic force of the spring.

### CROSS-REFERENCE TO RELATED APPLICATIONS

This application claims all benefits of Korean Patent Application No. 10-2009-0017850 filed on Mar. 3, 2009 in the Korean Intellectual Property Office, the disclosures of which are incorporated herein by reference.

### BACKGROUND OF THE INVENTION

1. Field of the Invention

The invention relates to a device for opening and shutting a nozzle of a cosmetic case, and more particularly, to a device for opening and shutting a nozzle of a cosmetic case wherein an airless pump of the cosmetic case is provided with a means for opening and shutting a nozzle, which enables the nozzle to be opened during the use of the cosmetic case and to be shut during the non-use of the cosmetic case, to maintain cleanness around the nozzle, and to prevent the contents from being solidified to block a passage and scent or smell from coming off and the remaining contents on a discharge passage from being contaminated and deteriorated and the microbes from being generated due to introduction of the outside air.

2. Description of the Prior Art

In general, a cosmetic case, which stores various cosmetics of a liquid or gel state, is provided at its injection port with a compression-type airless pump enabling the stored contents to be accurately discharged to the outside by a predetermined amount.

The airless pumps of various structures have been suggested. A general principle of the pump is as follows: the pump is mounted on a nozzle cap enabling an injection port of the cosmetic case to be opened and shut. When an operation button is pushed by a finger, vacuum pressure is resultantly generated therein, so that the contents stored in the case are discharged to the outside through the nozzle by a predetermined amount.

An example of the conventional cosmetic case having the airless pump will be described. As shown in FIG. 1, the cosmetic case is formed into a cosmetic case of a dual structure having an inner case 10 that stores the contents and an outer case 20 that protects the inner case and is also provided for decoration. The inner case 10 is provided at its opening with an airless pump 30 for pumping the contents.

The airless pump 30 is mounted at an injection port of the inner case 10 so that an operation cylinder 31 and a nozzle cap 32 are overlapped interiorly and exteriorly. The nozzle cap 32 is mounted with an operation button 34 having a nozzle 33.

In addition, a piston 35 is vertically connected to a central lower part of the nozzle cap 32 so that the piston can ascend and descend in the operation cylinder 31. The piston 35 is mounted with a valve 37 by a piston support 36 having an orifice, so that the piston opens and shuts a fluid passage while ascending and descending in the operation cylinder 31. The operation button 34 is elastically mounted by a return spring 38.

Additionally, the operation cylinder 31 has therein a fluid passage communicating with the inner case 10 and the fluid passage is provided with an open-and-shut valve 39 that opens and shuts the fluid passage by vacuum pressure resulting from a pumping operation.

According to the above cosmetic case, when the operation button 34 is pushed, it descends while compressing the return spring 38. Due to the resultant pressure, the piston 35, the valve 37 and the piston support 36 are also moved downward, thereby compressing the inside of the operation cylinder 31.

Thereby, the vacuum pressure in the operation cylinder 31 is increased, so that a space between the valve 37 and the piston support 36 is opened. As a result, the contents in the operation cylinder 31 are discharged to the outside through the nozzle 33 of the operation button 34 via the opened space and the orifice of the piston support 36.

At this time, the open-and-shut valve 39 maintains the state in which the fluid passage is shut by the pressure of the operation cylinder 31.

Meantime, when the pushed operation button 34 is released, the piston 35, the valve 37 and the piston support 36 are upward moved to their original positions by the return force of the return spring 38. Thereby, the vacuum pressure prevails in the operation cylinder 31 to open the fluid passage of the open-and-shut valve 39, so that the contents in the inner case 10 are introduced into the operation cylinder 31 and stands by for next discharge operation.

However, according to the above structure, a part of the operation cylinder 31, which is a central position of the fluid passage, is opened and shut by the valve 37. Thus, the contents, which will be discharged through the nozzle 33 from the inner case 10, are not completely discharged and stay on the fluid passage from the corresponding part to the nozzle 33.

Thus, the fluid passage between the nozzle 33 and the operation cylinder 31 always communicates with the outside. As a result, the remaining contents staying on the fluid passage flows to the outside, so that the nozzle 33 becomes dirty.

In addition, during the non-use of the cosmetic case, the outside air is introduced in a reverse direction through the nozzle 33, so that the contents remaining in the fluid passage is easily dried or the scent or smell is emitted by evaporation, thereby deteriorating the inherent ingredients. Furthermore, when the above state sustains for a long time, the contents are contaminated or deteriorated.

In particular, when the contents in the fluid passage are solidified due to the above problems, the contents block the fluid passage, so that the smooth pumping operation is not made. Further, due to such loads, the related parts may malfunction.

In the meantime, in order to improve the above structure, the applicant filed a utility model application (Korean utility model registration No. 282746).

As can be seen from the above utility model application, a tip valve that is advanced and retreated by a return spring is mounted on a nozzle of a pump. During the operation, the tip valve is retreated by the discharge pressure of the contents while compressing the return spring, thereby opening the nozzle. During the non-operation, the tip valve shuts the nozzle by the elastic force of the return spring.

However, according to the above structure, the tip valve is retreated by the discharge pressure. Thus, when the discharge pressure of the contents is excessively high, the accurate operation is not made, so that an expected effect is not sufficiently obtained.

In addition, the return spring made of metal is mounted on the passage through which the contents are discharged. Thus, a malfunction may be caused due to the insufficient elastic force of the return spring. In addition, since the return spring is made of metal, it has a bad influence on the contents.

### SUMMARY OF THE INVENTION

Accordingly, the present invention has been made to solve the above problems occurring in the prior art.

An object of the invention is to provide an device for opening and shutting a nozzle of a cosmetic case wherein an airless pump of the cosmetic case is provided with a means for opening and shutting a nozzle to open the nozzle before operating the pump when using the cosmetics and thus to smoothly discharge the contents and to immediately shut the nozzle when not using the cosmetics, thereby blocking the outside air from being introduced therein to prevent the contents from being contaminated and deteriorated and the scent or smell from being emitted.

In order to achieve the above object, according to the invention, a means for opening and shutting a nozzle by a push operation is provided to a cosmetic case having an inner case, an outer case and an airless pump.

The means for opening and shutting a nozzle has an operation button body that ascends and descends by a push operation of a user and has a front to which a nozzle is engaged and therein a discharge passage through which the contents are discharged to the outside. The operation button body is formed at its upper face with a guide pipe to which the nozzle is engaged and at its rear side with a support axis and a spring holder.

In addition, the guide pipe is mounted therein with a rod-shaped pin for opening and shutting a nozzle by an advance and retreat operation and a push pin having a ring-shaped engagement recess parallel with the rod-shaped pin. A rear side of the push pin is engaged with a spring enabling the pin for opening and shutting a nozzle and the push pin to move forward. The support axis of the operation button body is provided with an operation lever that is pivoted about a hinge hole, which is a support point, and is engaged with the engagement recess of the push pin to move the push pin and the pin for opening and shutting a nozzle backward by a push operation of a button cover. During the use of the case, the nozzle is opened before a pumping operation for using the cosmetics, thereby discharging the cosmetics smoothly. During the non-use of the case, the nozzle is shut by the elastic force of the spring.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view showing a structure of a cosmetic case according to the prior art;

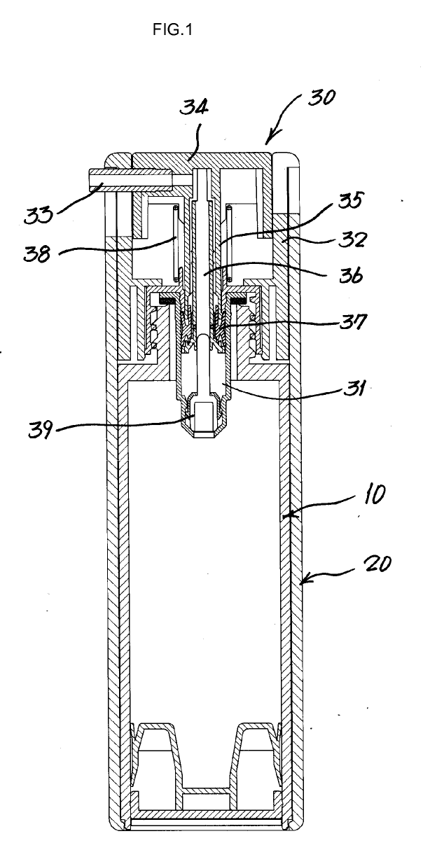

FIG. 2 is a perspective view of a cosmetic case to which the invention is applied;

FIG. 3 is a sectional view of FIG. 2;

FIG. 4 is a sectional view showing an upper part in FIG. 3;

FIG. 5 is a partial sectional view taken along a line of A-A′ of FIG. 4;

FIG. 6 is a partial sectional view taken along a line of B-B′ of FIG. 4;

FIG. 7 is an exploded perspective view showing a means for opening and shutting a nozzle according to an embodiment of the invention;

FIG. 8 is a partial perspective view showing principal parts of FIG. 7;

FIG. 9 shows an operating state of the invention, showing an operation standby state;

FIG. 10 shows a first operation state; and

FIG. 11 shows a second operation state.

### DETAILED DESCRIPTION OF THE PREFERRED EMBODIMENTS

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

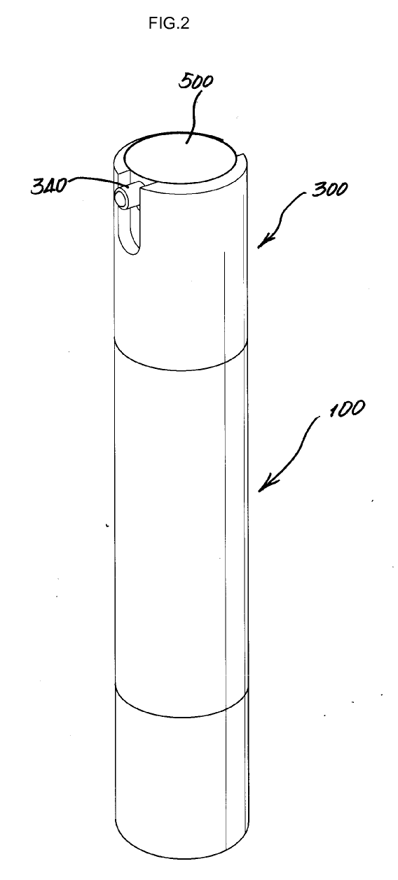

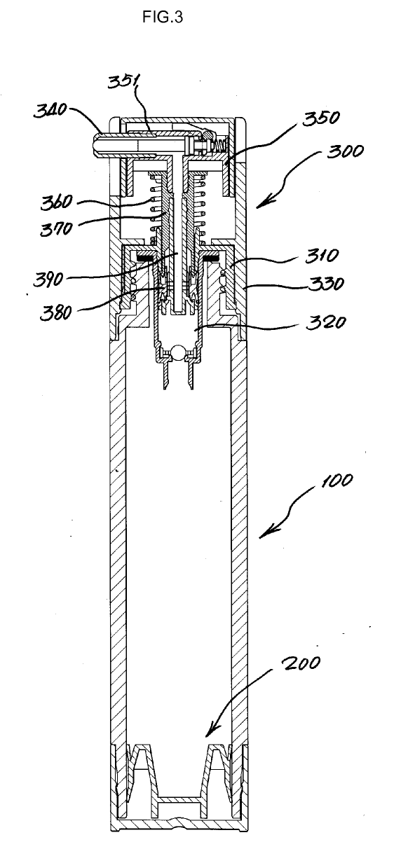

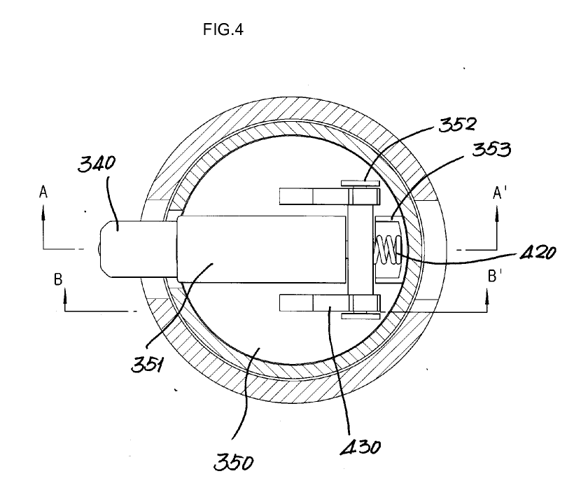

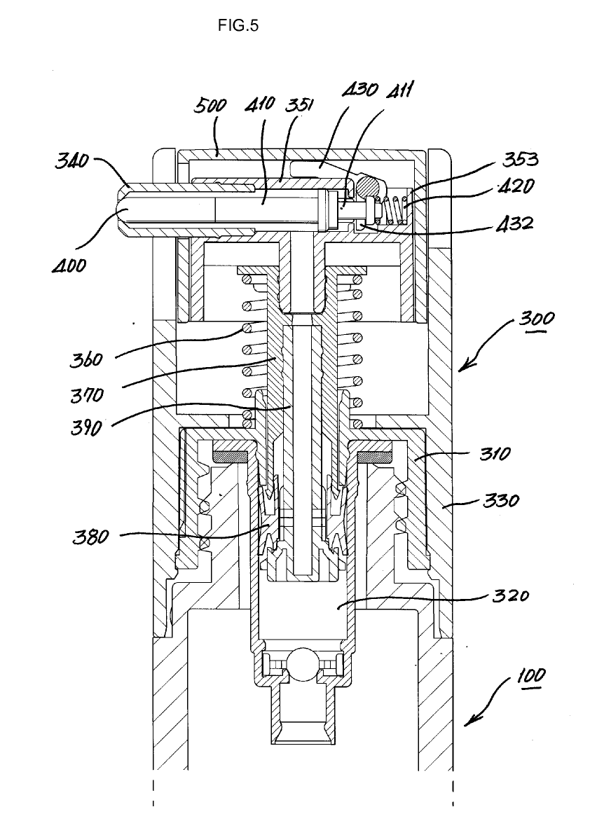

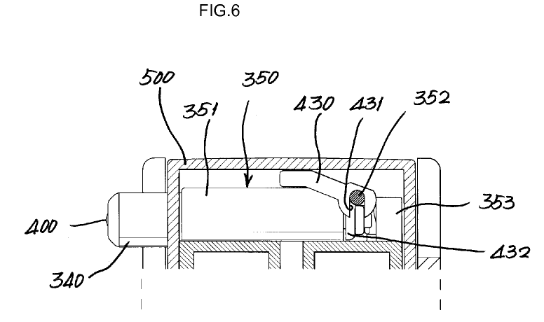

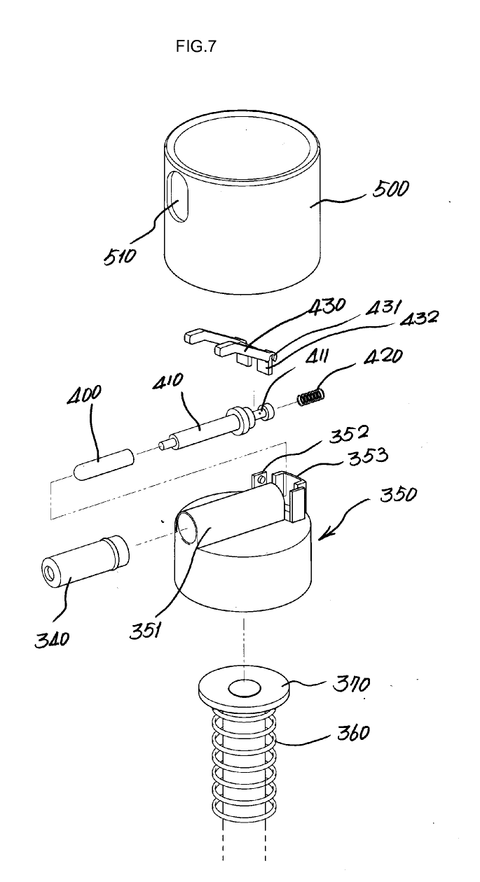

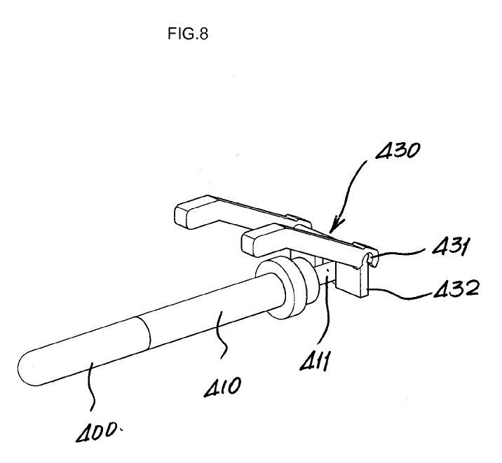

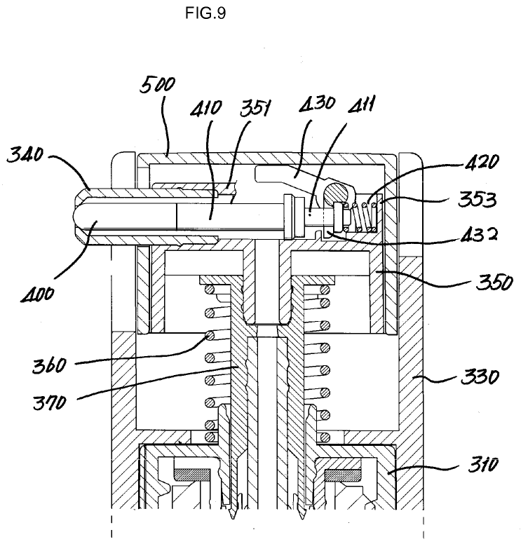

FIGS. 2 and 3 are sectional views showing an overall structure of a cosmetic case to which the invention is applied, FIGS. 4 to 8 show principal parts of the invention and FIGS. 9 to 11 sequentially show operating states.

As can be seen from the drawings, the cosmetic case to which the invention is applied comprises a cylindrical case 100 in which the contents are safely stored. The inside of the case 100 is maintained under vacuum state, so that the contents are safely stored. In addition, the case 100 is provided at its lower part with a push plate 200 that is moved upward by vacuum pressure to push up the contents, in accordance with the contents to be discharged by pumping force of a pump.

The case 100 is made of glass or synthetic resin. However, if necessary, the case 100 may be formed therein with a separate inner case for safely storing the contents.

In other words, the case 100 may be made of rigid glass or synthetic resin and the inner case may be made of aluminum, laminate and the like for improving preservation of the contents, which form a case body of a dual structure.

Additionally, an injection port of the case 100 is mounted with an airless pump 300 that is engaged to the injection port of the case 100. The airless pump has a function of pumping the contents stored in the case to the outside through a nozzle by vacuum pressure resulting from a push operation of a user.

As can be seen from FIG. 2, the pump 300 is structured in such a manner that an operation cylinder 320 and a nozzle cap 330 are engaged by an airtight cap 310 that is thread-engaged to the injection port of the case 100 and an operation button body 350 having a nozzle 340 engaged thereto is mounted in an upper part of the nozzle cap 330 so that the operation button body can be moved upward and downward by the elastic force of a return spring 360.

To be more specific, the case 100 is mounted at its upper part with the nozzle cap 330 and sealingly engaged at its lower inside with the operation cylinder 320 in a form that the cylinder is inserted into the injection port of the case 100.

In addition, the operation button body 350 is elastically mounted at its lower part with a piston 370 by the return spring 360 and a lower part of the piston is inserted into the operation cylinder 320, so that the piston is moved upward and downward depending on the operations of the operation button 350. A valve 380 and a piston support 390 are respectively engaged to a lower end and an inside of the piston.

The piston support 390 has an orifice at is lower periphery and an opened upper part, so that it communicates with the nozzle. The valve 380 made of high elastic rubber material is engaged to the outer periphery of the piston support and opens and shuts the orifice.

To be more specific, while the piston support 390 ascends and descends in a same interval as the piston 370 ascends and descends, it enables the valve 380 engaged to the outer periphery thereof to open and shut the orifice, thereby performing the pumping operation.

The above structure is approximately same as that of the prior art. However, the invention improves the structure of the operation button body 350 of the airless pump 300 and provides a means for opening and shutting a nozzle on a fluid passage in the operation button body 350.

As can be clearly seen from the drawings, the means for opening and shutting a nozzle has the operation button body 350 that is provided to an upper part of the airless pump 300 and has a guide pipe 351 mounted in the nozzle cap 330, engaged at its upper surface with the nozzle 340 and enabling the contents to be discharged to the outside and support axes 352 and a spring holder 353 at its rear side.

The operation button body 350 has therein a pin 400 for opening and shutting a nozzle, which is engaged to the nozzle 340 and is advanced and retreated, a push pin 410 interference-fitted at a rear surface of the pin 400 and having a ring-shaped engagement recess 411, a spring 420 engaged at a rear part of the push pin 410 and enabling the pin 400 and the push pin 410 to be forward moved all the time and an operation lever 430 axis-connected to the support axes 350 of the operation button body 350, having a lower end engaged to the engagement recess 411 of the push pin 410 and enabling the push pin 410 to be moved forward and backward. The operation button body 350 is provided at its upper part with a button cover 500 having a nozzle guide hole 510 at its front and enabling the operation lever 430 to be operated by a push operation of a user.

To be more specific, the operation button body 350 is engaged to the inner upper part of the nozzle cap 330 and is repeatedly moved upward and downward by a push operation of a user and the elastic force of the return spring 360, thereby generating pumping power. That is, the operation button body has the same function as the prior art. However, the operation button body 350 is provided with the means for opening and shutting a nozzle according to the invention, so that the structure thereof is different from the prior art.

The operation button body 350 has therein the fluid passage, which communicates at its lower part with the case 100 through the piston 370, the piston support 390 and the like, and at its upper face the guide pipe 351 communicating with the fluid passage and formed to protrude horizontally. The nozzle 340 is inserted through a front of the guide pipe.

In other words, the guide pipe 351 is horizontally formed at the upper part of the operation button body 350 and communicates with the fluid passage, thereby discharging the contents to the outside through the nozzle 340 engaged at the front of the guide pipe.

In addition, the support axes 352 facing each other at the rear part of the guide pipe 351 are formed so that the operation lever 430 is axis-connected to the support axes. Further, the spring holder 353 to which the spring 420 is engaged is formed at the rear end of the guide pipe.

Additionally, the guide pipe 351 is provided therein with the pin 400 for opening and shutting a nozzle, which opens and shuts the front end of the nozzle 340. The pin is formed into a rod shape, is structured to open and shut the inside of the nozzle 340 by the advance and retreat operation thereof and is engaged at its rear side with the push pin 410.

The push pin 410 has a rod shape and is formed with the engagement recess 411 along the periphery direction thereof. In the meantime, the pin 400 for opening and shutting a nozzle is engaged to the front side of the push pin and the spring 420 is engaged to the rear side thereof.

The spring 420 is a coil spring providing the elastic force. One end thereof is engaged to the rear side of the push pin 410 and the other end is engaged to the spring holder 353 of the operation button body 350, thereby pushing the push pin 410 and the pin 400 in a forward direction.

The operation lever 430 operating the push pin 410 is axis-connected to the support axes 352 of the operation button body 350 and is operated by the push operation of the button cover 500. The operation lever is upward bent and has at both sides thereof a hinge hole 431 that is axis-connected to the support axes 352 of the operation button body 350 and at the lower part thereof an operation piece 432 that is vertically connected to the engagement recess 411 of the push pin 410 and operates the push pin.

The operation piece 432 has at its center a circular groove that is opened downward. Through the groove, the operation piece is stably inserted into the engagement recess 411 of the push pin 410. In addition, the operation piece is pivoted about the hinge hole 431, which is a support point, thereby advancing the push pin 410.

In addition, the button cover 500 pivoting the operation lever 430 is formed into a cylindrical shape having an opened lower part, is engaged to the operation button body 350 in a manner of covering the upper part of the operation button body and has the vertically-elongated nozzle guide hole 510 formed at its front through which the nozzle 340 is inserted and guided.

The means for opening and shutting a nozzle structured as described above is applied to the cosmetic case in which the airless pump 300 is mounted to the upper part of the case 100 and is assembled to the inner upper position of the airless pump 300, as can be seen from the drawings.

To be more specific, in the means for opening and shutting a nozzle, the operation button body 350 is assembled with the piston 370 and the piston support 390 in the nozzle cap 330 and the nozzle 340 is assembled to the front end thereof.

In addition, the pin 400 for opening and shutting a nozzle and the push pin 410, which are connected to each other, are mounted in the guide pipe 351 of the operation button body 350 and the spring 420 is assembled to the spring holder 353 at the rear side of the guide pipe. As a result, in normal times, the push pin 410 and the pin 400 for opening and shutting a nozzle are forced forward by the elastic force, thereby shutting the entrance of the nozzle 340.

Further, the operation lever 430 is axis-connected to the support axes 352 by the hinge hole 431 and the operation piece 432 formed at the lower part of the operation lever is engaged to the engagement recess 411 of the push pin 410.

At this time, since the push pin 410 is forced forward, the operation piece 432 formed at the lower part of the operation lever 430 is located at the rear end of the engagement recess 411. Thereby, the operation lever is upward pivoted about the hinge hole 431 that is a support point, thereby pushing up the button cover 500.

The above state is a normal state that the cosmetics in the cosmetic case are not used, i.e., stored. In this state, as can be seen from FIG. 9, the pin 400 for opening and shutting a nozzle and the push pin 410 are advanced by the elastic force of the spring 420, so that the pin 400 shuts the nozzle 340. Thus, it is possible to basically prevent the outside air and foreign substance from being introduced through the nozzle 340.

Accordingly, it is possible to prevent the contents remaining in the fluid passage from being dried due to the evaporation, contaminated and deteriorated by the outside air. Further, it is possible to block the contents from flowing out to the exterior from the interior, so that the cleanness is always maintained.

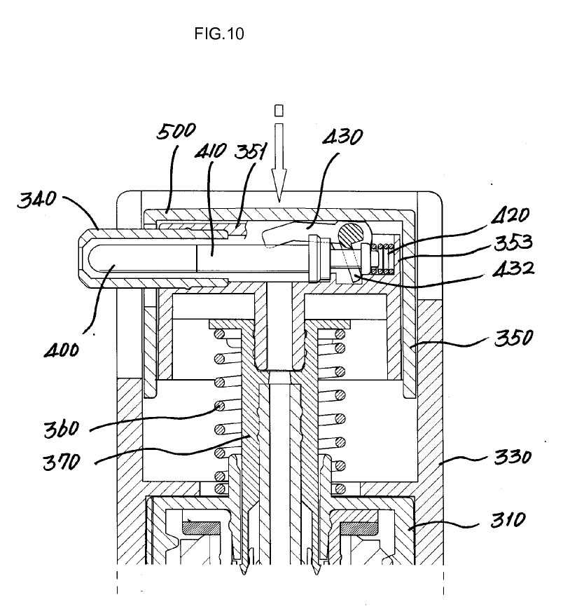

Under such state, when a user intends to use the cosmetics, the user pushes the button cover 500 of the operation button exposed to the outside. Thereby, as can be seen from FIG. 10, the button cover 500 is moved downward to a location close to the upper surface of the operation button body 350, thereby pushing the operation lever 430 positioned at the bottom surface of the operation button body.

While the operation lever 430 is pivoted about the hinge hole 431 connected to the support axes 352, the operation piece 432 pushes the push pin 410 backward.

The push pin 410 is moved backward while compressing the spring 420. At the same time, the pin 400 for opening and shutting a nozzle, which is integrally assembled to the front of the push pin, is backward operated to open the shut nozzle 340.

The above operation can be called as a first operation and an operation in which a user continues to apply the pushing force and thus the button cover 500 push-operates the operation button body 350 can be called as a second operation.

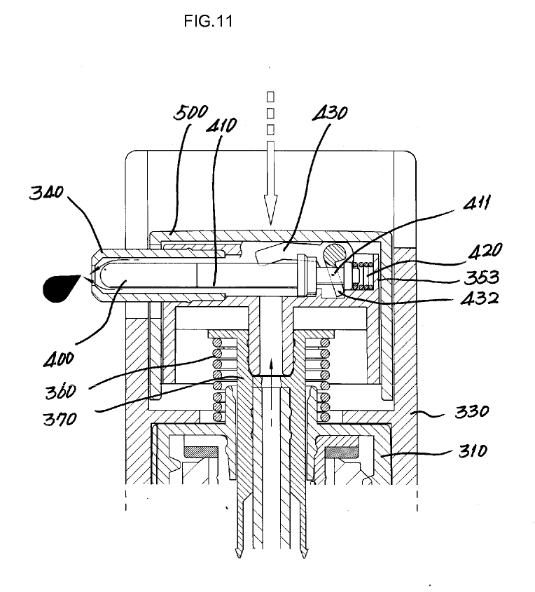

As the operation button body 350 is pushed to compress the return spring 360 by the second operation, the airless pump 300 is operated, so that the piston 370, the piston support 390 and the valve 380 are downward moved into the operation cylinder 320, thereby compressing the operation cylinder 320, as can be seen from FIG. 11. Thus, the valve 380 opens the hole of the piston support 390, so that the contents in the operation cylinder 320 are discharged to the nozzle 340 through the fluid passage in the guide pipe 351 via the hole, the piston support 390 and the inside of the piston 370.

Under such state, when the force applied in the second operation is released, i.e., the applied force is released a little without being completely released, the operation button body 350 is moved upward by the elastic force of the compressed return spring 360, so that the piston 370, the valve 380 and the piston support 390 are also moved upward and returned to their original positions.

The high vacuum pressure is thus generated in the operation cylinder 320, so that the ball valve at the lower part thereof opens the lower passage by the vacuum pressure. Thereby, the contents in the case 100 are filled in the operation cylinder 320 and stands by for next operation.

At this time, it is preferable that the pumping operation of the contents by the push operation of the operation button body 350 is performed within a range of the second operation. By continuously performing the second operation, it is possible to discharge the contents smoothly and stably.

When the push operation is completely released after the using of the cosmetics is completed by the pumping operation, the pressure in the fluid passage is completely released, so that the means for opening and shutting a nozzle is also returned to its original position.

In other words, the push pin 410 and the pin 400 for opening and shutting a nozzle, which have been retreated by the push operation of the button cover 500, are advanced by the elastic force of the spring 420, thereby shutting the nozzle 340. At the same time, the rear end of the push pin 410 pushes the operation piece 432 of the operation lever 430 in the forward direction, thereby pivoting the operation lever 430. As a result, the button cover 500 is moved upward and returned to its original position.

Accordingly, by the above feedback operation and the operation of the means for opening and shutting a nozzle, it is possible to maintain the nozzle clean all the time. Furthermore, even during the standby state, the outside air is not introduced into the pump, so that it is possible to safely protect the contents.

As described above, according to the invention, the separate means for opening and shutting a nozzle is provided to the nozzle through which the contents are discharged to the outside. Thus, during the use of the cosmetics, the nozzle is first opened before the contents are pumped, so that the contents are smoothly discharged. When the pumping operation is completed, the opened nozzle is immediately shut by the elastic force of the return spring, so that the remaining contents are prevented from flowing out to the outside. As a result, the exterior appearance is improved and the inherent scent or smell of the cosmetics is prevented from being emitted to the outside.

In addition, during the non-use of the cosmetics, the exterior air and foreign substance are basically blocked from being introduced. Thus, it is possible to prevent the contents from being contaminated and deteriorated. In addition, it is possible to prevent the contents from being solidified due to the evaporation and the ingredients from being deteriorated.

While the invention has been shown and described with reference to certain preferred embodiments thereof, it will be understood by those skilled in the art that various changes in form and details may be made thereto without departing from the spirit and scope of the invention as defined by the appended claims.

What is claimed is:

1. A device for opening and shutting a nozzle of a cosmetic case, the device comprising:
an operation button body that is provided to an upper part of the cosmetic case and has a guide pipe engaged at its upper surface with a nozzle and enabling the contents to be discharged to the outside and support axes and a spring holder at its rear side;
a pin for opening and shutting a nozzle that is formed into a rod shape and inserted in the guide pipe of the operation button body and opens and shuts the nozzle by advance and retreat movement;
a push pin that is integrally assembled to a rear side of the pin for opening and shutting a nozzle and has a ring-shaped engagement recess;
a spring that is inserted into a rear part of the push pin and the spring holder and enables the pin for opening and shutting a nozzle and the push pin to be moved forward all the time;
an operation lever that has a hinge hole axis-connected to the support axes of the operation button body and at its lower part an operation piece to be engaged to the engagement recess of the push pin; and
a button cover that is engaged to an upper part of the operation button body, has at its front side a nozzle guide hole and enables the operation lever to be pivoted by a push operation by a user.
